(19) United States
(12) Patent Application Publication
(10) Pub. No.: US 2009/0190787 A1
(43) Pub. Date: Jul. 30, 2009

(54) Speaker

(76) Inventors: William R. Pieklik, Baltimore, MD (US); Timothy P. Conroy, Annapolis, MD (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/020,441

(22) Filed: Jan. 25, 2008

(51) Int. Cl. H04R 1/02; H04R 9/06

(52) U.S. Cl. 381/386; 381/395; 381/334

(57) ABSTRACT

A speaker apparatus comprising a speaker housing member and a supporting bracket that can be easily installed on a spa or any other desired supporting surface. The speaker apparatus is configured such that the speaker housing member can move between a plurality of different positions relative to the supporting bracket, including at least an upward position and a downward position. In some embodiments, the speaker apparatus has a visual display that changes the orientation of the information so that the information is displayed in an upright orientation regardless of the orientation of the speaker housing member. In some embodiments, the speaker apparatus can comprise controls to control the speaker apparatus, audio signal source, spa, or other components.

### BACKGROUND OF THE INVENTION

1. Field of the Invention

The invention is directed generally to a speaker, and more particularly to a hinged speaker.

2. Description of the Related Art

Music is becoming more and more a part of every day life. Many people enjoy listening to music and want to do so in their hot tubs, spas, pools, and other similar recreational and therapeutic devices. For this purpose, speakers and the like are often installed near water sources or in locations exposed to moisture and other elements. However, to avoid contact between the water and the speaker components and wires, speakers are often installed far from the water source, often degrading the sound quality experience of the listener.

### SUMMARY OF THE INVENTION

An aspect of the invention is directed to a speaker that has a bracket member configured to attach to a generally vertical support surface. The speaker further includes a speaker housing that has at least one audio driver and a structure coupling the speaker housing to the bracket member so as to allow the speaker housing to move between at least a first position and a second position relative to the bracket member. At least a portion of the speaker housing is higher than the bracket member when in the first position than when in the second position.

Another aspect of the invention is a spa speaker that has a bracket member configured to be fixed to a side of a spa and a speaker housing supporting at least one audio driver. The speaker further includes a structure movably coupling the bracket member to the speaker housing so as to allow the speaker housing to rotate relative to the bracket member and between at least an extended position and a stowed position. The speaker housing is disposed above a top surface of the spa when in the extended position so as to direct sound in a general direction toward the spa. The speaker housing is disposed below the top surface of the spa when in the stowed position so as to direct sound in a general direction away from the spa.

Another aspect is a method for attaching a low-profile, flip-up speaker to a spa that includes providing a speaker that has a bracket member, a speaker housing, and a coupling structure between the bracket member and the speaker housing, and at least one audio driver disposed within the speaker housing. The method further includes fixing the bracket member to a supporting surface of the spa such that the bracket member is located below a top surface of the spa. The speaker housing is rotatable relative to the fixed bracket member and between at least an extended position and a stowed position. The speaker housing is disposed above the top surface of the spa when in the extended position so as to direct sound in a general direction toward the spa. The speaker housing is disposed below the top surface of the spa when in the stowed position.

The systems and methods of the invention have several features, no single one of which is solely responsible for its desirable attributes. Without limiting the scope of the invention as expressed by the claims, its more prominent features have been discussed briefly above. After considering this discussion, and particularly after reading the section entitled “Detailed Description of the Preferred Embodiments,” one will understand how the features of the system and methods provide several advantages over conventional speakers.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The following are brief descriptions of the drawings.

FIG. 1 is a perspective view of a front portion of a speaker apparatus according to an embodiment of the present invention, showing a speaker housing member in a first or upward position.

FIG. 2 is a rear perspective view of the speaker apparatus from FIG. 1.

FIG. 3 is a perspective view of the speaker apparatus from FIG. 1 in a second or downward position.

FIG. 4 is a side view of the speaker apparatus from FIG. 3.

FIG. 5 is top view of the speaker apparatus from FIG. 1, showing two internal audio drivers in dashed lines.

FIG. 6 is an exploded assembly view of the speaker apparatus from FIG. 1.

FIG. 7 is an enlarged view of an upper portion of the exploded assembly illustration shown in FIG. 6.

FIG. 8 is a perspective view of the back of a portion of the speaker apparatus of FIG. 1, showing a portion of the speaker housing member 22 in an extended or upward position.

FIG. 9 is an exploded perspective view of a first portion of the hinge assembly illustrated in FIG. 6.

FIG. 10 is an exploded perspective view of a second portion of the hinge assembly illustrated in FIG. 6.

FIG. 11 is a perspective view of a shaft member from FIGS. 9 and 10.

FIG. 12 is a perspective view of a limit member from FIGS. 9 and 10.

FIGS. 13A and 13B are a perspective view and a side view, respectively, of a wave washer from FIGS. 9 and 10.

FIG. 14 is a perspective view of a washer from FIGS. 9 and 10.

FIG. 15 is a perspective view of a portion of the speaker apparatus from FIG. 1 with a first bracket cover and a second bracket cover removed to show the hinge assembly.

FIG. 16 is a perspective view of a first index member from FIG. 15.

FIG. 17 is an enlarged view of a lower portion of the exploded assembly illustrated in FIG. 6.

FIG. 18 is a front perspective view of a speaker apparatus according to another embodiment of the present invention that includes a visual interface and control panel, showing the speaker housing member in a first or upward position.

FIG. 19 is a perspective view of a front portion of the speaker apparatus from FIG. 18, showing the speaker housing member in a second or downward position.

### DETAILED DESCRIPTION OF THE PREFERRED EMBODIMENTS

The following detailed description is now directed to certain specific features of the embodiments of a speaker apparatus 20. In this description, reference is made to the drawings wherein like parts are designated with like numerals throughout the description and the drawings. Also, although the term “spa” is used throughout this description, it is to be understood that the present invention is applicable to a spa, spa enclosure, hot tub, hot tub enclosure, pool, and other fluid bearing recreational or therapeutic devices. Further, it should be readily apparent to one of ordinary skill in the art that the speaker apparatus 20 is not limited to use with a spa. The speaker apparatus 20 can be mounted on any surface where the user desires a rotatable speaker system such as, but not limited to, tables, counter-tops, work benches, desks, and other desired surfaces in a user's home, boat, car, or other vehicle, recreational or otherwise. For example, in some embodiments, the speaker apparatus 20 can be configured to be mountable to the underside of a table, desk, or other flat surface such that the speaker housing member 22 can be moved or rotated above the top planar surface of such object. Accordingly, as used herein, the term “spa” is to be understood to mean all such fluid bearing recreational or therapeutic devices, as well as the other objects listed above.

In some embodiments, the speaker apparatus 20 is mounted to the objects described above with little modification to such objects. All that may be required to mount the speaker apparatus 20 to the desired object are fasteners that secure a mounting bracket to the desired supporting surface, as described below. Thus, in most cases, the only modification to the supporting surface that is required to install the speaker apparatus 20 is the formation of a few pilot holes for the bracket mounting screws.

As will be described herein, in some embodiments, the speaker apparatus 20 is preferably configured such that the speaker housing member 22 can be moved or rotated by a user from a generally upward or extended position (referred to herein as a first position) to a generally downward or stowed position (referred to herein as the second position). When the speaker housing member 22 is in a generally upward position, the speaker apparatus 20 is preferably configured such that a portion of the speaker housing member 22 extends above the spa such that the sound from the speaker housing member 22 may be directed toward the inside of the spa and the occupants therein.

In contrast, when the user or users desire to direct the sound from the speaker apparatus 20 away from the spa, in some embodiments, the speaker housing member 22 is moved or rotated to a generally downward or stowed position. In this position, the speaker housing member 22 is preferably positioned below the top surface of the spa, and the speaker housing member 22 preferably directs sound away from the spa so that a user or users can listen to the sound emanating from the speaker apparatus 20 on a patio or other area near the spa. Thus, the speaker apparatus 20 can be operated in both the stowed and extended positions. The speaker apparatus 20 can also be used when the spa cover is on the top surface of the spa.

Additionally, in the generally downward position, the speaker housing member 22 is preferably protected from impact with a spa cover or other object. In the generally downward position, the speaker housing member 22 is also preferably less likely to be damaged by exposure to moisture, chemicals, sunlight, or other elements. Therefore, it is preferred that the speaker apparatus 20 be configured such that it can be easily positioned in the downward position during periods when the speaker apparatus 20 is not being used to supply sound to the inside of the spa. It is also preferred that the speaker apparatus 20 be configured such that it can be easily positioned in the upward position when the user or users desire to listen to sound from the speaker apparatus 20 in the spa.

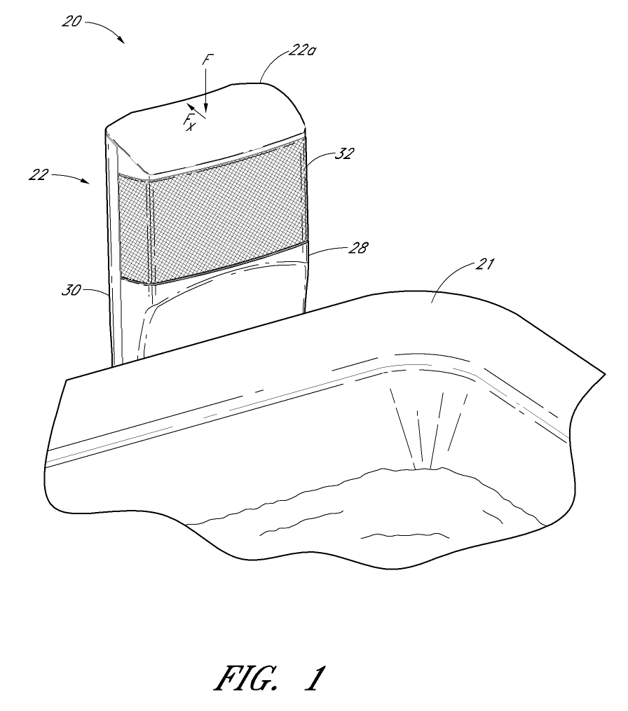

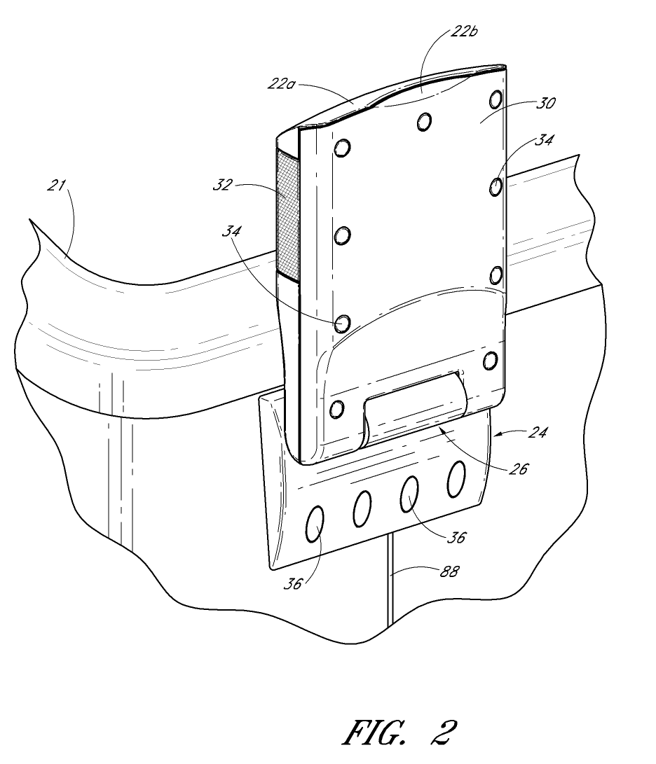

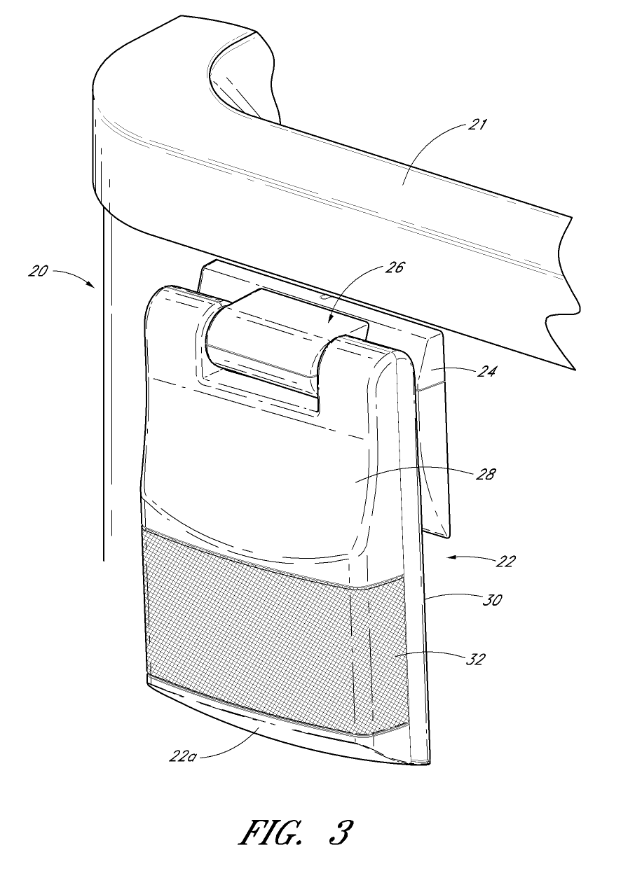

FIG. 1 is a perspective view of a front portion of a speaker housing member 22 of the speaker apparatus 20 according to a preferred embodiment of the present invention. The speaker housing member 22 is in an upward, unfolded, or extended position relative to a spa 21. FIG. 2 is a rear perspective view of the speaker apparatus 20 from FIG. 1. FIG. 3 is a perspective view of the speaker apparatus 20 from FIG. 1 in a stowed or downward position.

The speaker apparatus 20 comprises a speaker housing member 22 that is movable relative to a bracket member 24. The bracket member 24 is mounted to a suitable surface such as a side surface of the spa 21. Because the speaker housing member 22 is movable relative to the spa 21, the speaker housing member 22 is not fixedly attached to the spa. Rather, the speaker housing member 22 is supported by a hinge assembly 26 or other coupling structure. The coupling structure allows the speaker housing member 22 to move relative to the bracket member 24 between at least a first position and a second position. Preferably, in the first position, at least a portion of the speaker housing member 22 is disposed above the side of the spa 21. When the speaker housing member 22 is in the second position, the speaker housing member 22 is disposed in a position lower than the first position.

The hinge assembly 26 or other coupling structure allows the speaker housing member 22 to move relative to the bracket member 24 between the first and second positions. In the illustrated embodiment, a hinge assembly 26 connects the speaker housing member 22 to the bracket member 24. Of course other coupling structures could be used between the bracket member 24 and the speaker housing member 22. For example, the coupling structure could be a ball-and-socket or a tongue and groove coupling structure. With the tongue and groove coupling structure, the speaker housing member 22 would preferably be movable between at least a first and second position. Additionally, in some embodiments, the coupling structure could be a combination of a ball-and-socket and tongue and groove. In this configuration, the speaker housing member 22 would preferably be movable between at least a first and second position with the tongue and groove coupling structure, and rotatable to a desired orientation with the ball-and-socket coupling structure. In some embodiments, the coupling structure could be any structure or combination of structures known in the field that would allow the speaker housing member 22 to move between at least a first and second position, and allow the speaker housing member 22 to be rotatable about a longitudinal axis through the approximate longitudinal center of the speaker housing member 22.

Movement of the speaker housing member 22 can be achieved by, for example, rotating the speaker housing member 22 around an axis. The axis may be generally parallel to the side of the spa to which the bracket member 24 is attached as is illustrated in FIG. 1 or in a direction that is normal to the side of the spa 21. Alternatively, the speaker housing member 22 can be temporarily separated from the bracket member 24 when in the first position and re-attached to the bracket member 24 in the second position using, for example, a screw and wing nut, hook-and-loop, or other suitable type of fastener.

As shown in FIG. 3, the hinge assembly 26 connects the bottom of the speaker housing member 22 to an upper portion of the bracket member 24 so that the speaker housing member 22 is easily positioned above the top surface of the spa when the speaker housing member 22 is in an upward or extended position while maintaining a relatively low profile when in the stowed position.

In some embodiments, as will be described in greater detail below, the speaker apparatus 20 is preferably configured such that the speaker housing member 22 resists rotational motion about the hinge axis. In other words, the speaker apparatus 20 is configured such that the speaker housing member 22 remains at a desired angular orientation relative to the bracket member 24 until the user exerts a force on the speaker housing member 22. As such, in some embodiments, the speaker apparatus 20 is preferably configured such that, regardless of the position of the speaker housing member 22, a user will be required to exert a force on the speaker housing member 22 that is greater than the resistive force in order to position the speaker housing member 22 in a different angular position.

With reference to FIGS. 1-2, the speaker housing member 22 preferably comprises a first enclosure member 28, a second enclosure member 30, and a grill 32. The grill 32 may be fixed to or removable from the first enclosure member 28. The grill 32 is preferably configured to cover and protect the audio driver or drivers that are supported by the speaker housing member 22. In particular, the grill 32 is preferably configured to reduce the exposure of the audio driver(s) to sunlight, water, chemicals, or objects that can damage the speakers with prolonged exposure or impact.

With reference to FIG. 2, the speaker apparatus 20 preferably comprises a plurality of plugs 34. The plugs 34 are formed of a pliable material such as rubber or neoprene and are configured to seal the fastener holes and/or reduce the magnitude of the impact between the second enclosure member 30 and the bracket member 24 or the surface of the spa or other member that the second enclosure member 30 contacts when the speaker housing member 22 is moved to the downward or stowed position. Similarly, the bracket member 24 can also comprise plugs 36. The plugs 36 can be formed of a pliable material such as rubber or neoprene and are configured to seal the fastener holes. In some embodiments, the plugs 36 are preferably configured to reduce the magnitude of the impact between the second enclosure member 30 and the bracket member 24 when the speaker housing member 22 moves between the first and second positions.

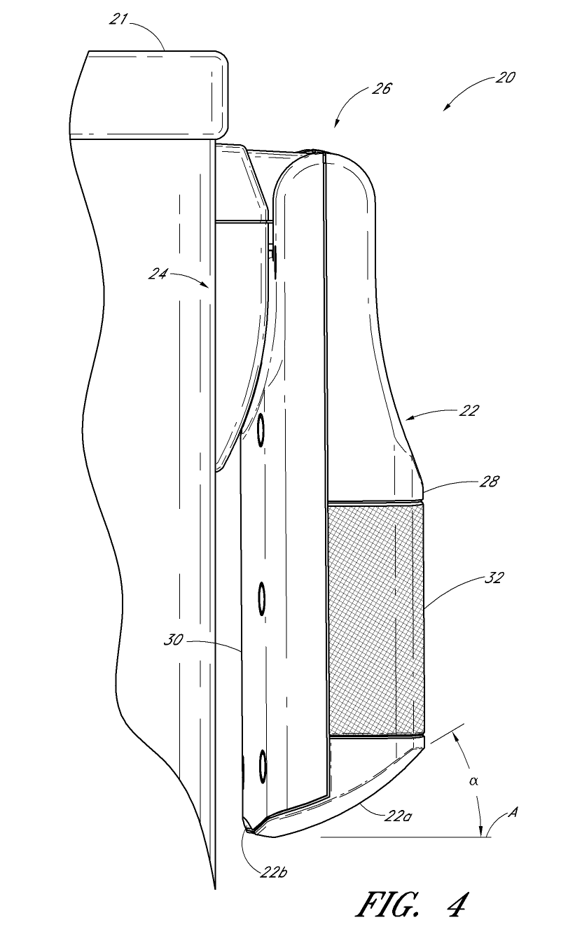

FIG. 4 is a perspective view of the side of the speaker apparatus from FIG. 1, showing the speaker housing member in a downward or stowed (i.e., second) position. With reference to FIG. 4, the speaker housing member 22 and bracket member 24 are preferably configured such that they have a slim or low profile in terms of the thickness of the speaker housing member 22 and bracket member 24 when the speaker housing member 22 is in the second position (i.e., the distance between the outermost surface of the speaker apparatus 20 and the supporting surface). In some embodiments, the distance between the outermost surface of the speaker apparatus 20 and the supporting surface is less than approximately 2.0 inches, or from approximately 2.0 inches to approximately 2.5 inches, or from approximately 2.5 inches to approximately 3.0 inches, or from approximately 3.0 inches to approximately 3.5 inches, or from or to any of the values within the above-listed ranges. As such, the speaker apparatus 20 is preferably configured to have a low depth profile that will reduce the likelihood that the speaker apparatus 20 will be struck and damaged by an object passing by the spa 21. The low profile of the speaker apparatus 20 can also enable a spa cover to easily drape over the speaker apparatus 20 when the speaker housing member 22 is in the downward position.

In some embodiments, the speaker housing member 22 moves to a downward position when the speaker housing member 22, being in an upward position, is impacted by a spa cover or other falling object. In some embodiments, as illustrated in FIGS. 1-4, an upper surface 22a of the speaker housing member 22 is angled so as to move from an upward position and toward the downward position when the speaker housing member 22 is impacted by a spa 21 cover or other falling object. In particular, with reference to FIG. 1, when the speaker apparatus 20 is impacted in a direction on the upper surface of the speaker housing member 22 by a generally downward vertical force F, due to the angular orientation of the upper surface 22a, a force component Fₓ will preferably result from the impact. In response to this force, the speaker housing member 22 rotates to a downward position. Thus, any impact damage is reduced since the speaker apparatus 20 moves out of the path of the falling object. As illustrated most clearly in FIG. 4, in some embodiments, the angle α of the upper surface 22a can be from approximately fifteen degrees or less to approximately twenty-five degrees, or from approximately twenty-five degrees to approximately forty degrees, or from approximately forty degrees to approximately fifty degrees, or from approximately fifty degrees to approximately sixty degrees or more, relative to a horizontal plane A.

The upper surface 22a of the speaker housing member 22 can be formed of, or coated with, a rubber material that has enhanced grip properties. A depression 22b can be formed in the top surface 22a of the speaker housing member 22 to enhance the gripping properties of the speaker housing member 22. The depression 22b can also be formed of, or coated with, a rubber material that has enhanced grip properties.

FIG. 5 is top view of the speaker housing member of the speaker apparatus from FIG. 1. As is illustrated in FIG. 5, the speaker housing member 22 houses one or more audio drivers 38a, 38b which are shown in dashed lines. In some embodiments, the speaker housing member 22 can support more than two audio drivers 38a, 38b. In the illustrated embodiment, the speaker housing member 22 supports two full range audio drivers 38a, 38b.

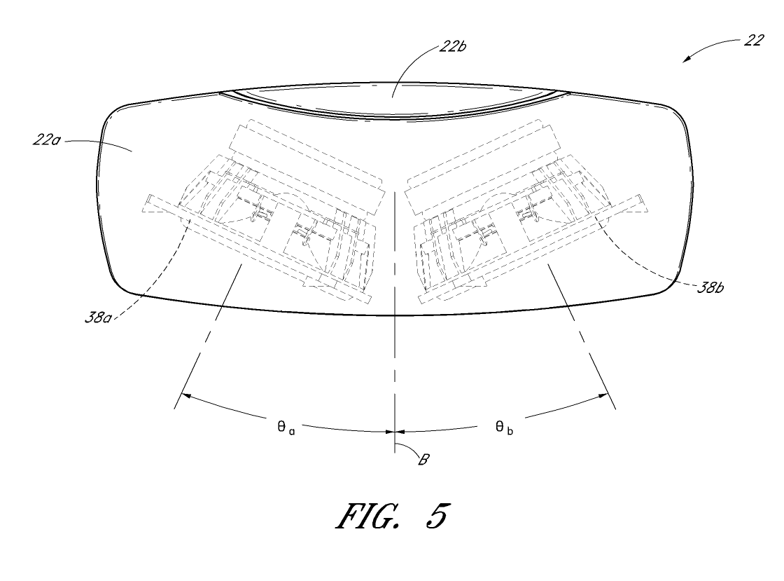

FIG. 6 is an exploded assembly view of the speaker apparatus 20. As illustrated in FIG. 6, the audio drivers 38a, 38b are attached to the first enclosure member 28 by screws 40. However, any other suitable fasteners or fastening method can be used to hold the audio drivers 38a, 38b to the first enclosure member 28 including, without limitation, bolts, pins, rivets, straps, snaps, welds, adhesive, or any combination of the foregoing. The audio drivers 38a, 38b can be sealed with respect to the first enclosure member 28 to inhibit moisture or contaminants from entering the inside of the speaker housing member 22.

The leftmost audio driver 38a can be supported by the speaker housing member 22 such that an axial centerline through the leftmost audio driver 38a is oriented at an angle θₐ that is approximately fifteen degrees relative to a vertical plane B bisecting the speaker housing member 22. For reference, the leftmost audio driver 38a refers to the audio driver 38 that is supported by the leftmost side of the speaker housing member 22 when the speaker housing member 22 is in an upward position, as illustrated in FIG. 5. The rightmost audio driver 38b is preferably mounted such that an axial centerline through the rightmost audio driver 38b is oriented at an angle θ_{b} that is approximately fifteen degrees relative to a vertical plane B bisecting the speaker housing member 22, in the opposite direction as compared to that of the leftmost audio driver 38a. Thus, in this configuration, the axial centerline through the leftmost audio driver 38a is preferably offset approximately thirty degrees relative to the axial centerline through the rightmost audio driver 38b.

In some embodiments, the leftmost audio driver 38a is positioned in the speaker housing member 22 such that the axial centerline through the leftmost audio driver 38a is oriented at an angle that is from approximately zero degrees to approximately fifteen degrees, or from approximately fifteen degrees to approximately twenty-five degrees, or from approximately twenty-five degrees to approximately thirty-five degrees, from approximately thirty-five degrees to approximately fifty degrees or more relative to a plane B bisecting the speaker housing member 22. In some embodiments, the rightmost audio driver 38b is positioned in the speaker housing member 22 such that an axial centerline through the rightmost audio driver 38b is oriented at an angle that is from approximately zero degrees to approximately fifteen degrees, or from approximately fifteen degrees to approximately twenty-five degrees, or from approximately twenty-five degrees to approximately thirty-five degrees, from approximately thirty-five degrees to approximately fifty degrees or more relative to a plane B bisecting the speaker housing member 22.

In some embodiments, the leftmost audio driver 38a can be positioned relative to the rightmost audio driver 38b so as to be symmetrical about an axial centerline through the speaker housing member 22. However, the speaker apparatus 20 is not so limited. The leftmost audio driver 38a can be positioned relative to the rightmost audio driver 38b so as to not be symmetrical about an axial centerline through the speaker housing member 22. For example, in some embodiments, the leftmost audio driver 38a can be oriented in the speaker housing member 22 such that an axial centerline through the leftmost audio driver 38a is approximately forty degrees relative to a plane B bisecting the speaker housing member 22, while the rightmost audio driver 38b can be oriented such that an axial centerline through the rightmost audio driver 38b is parallel to a plane B bisecting the speaker housing member 22, and vice versa.

As discussed above, two or more audio drivers may be supported within the speaker housing member 22. In some embodiments, any of the audio drivers may be positioned at any of a wide range of angular orientations relative to the speaker housing member 22. For example, in some embodiments, two audio drivers may be positioned and configured such that the sound produced by each of the audio drivers projects in substantially opposing directions so that sound can be heard from the speaker apparatus 20 in approximately opposite directions. Further, in some embodiments, three or more audio drivers may be supported by the speaker housing member 22 and oriented at approximately equal angular orientations to provide a more complete sound range. For example, a speaker apparatus 20 may be configured to comprise four audio drivers, each configured to project sound at an approximately 90° angle relative to an adjacent audio driver. In some embodiments, two or more speaker apparatuses 20 can be mounted to the spa 21. In this configuration, the speaker apparatuses 20 are preferably laterally spaced apart to increase the lateral range of the sound emanating from the speaker apparatuses 20 and improve stereo imaging.

The speaker apparatuses 20 can be installed by a user in any desired position on the spa or other supporting structure to provide the desired sound. Additionally, in some embodiments, each of the one or more speaker apparatuses 20 reproduces stereophonic sound (in contrast with a monophonic sound). In particular, in any of the embodiments described herein, the speaker apparatus 20 can be configured such that the leftmost audio driver 38a and the rightmost audio driver 38b produce sound in stereo such that a user sitting close to a single speaker apparatus 20 can still experience stereo sound quality. In some embodiments, the speaker apparatus 20 can comprise a switch that the user can adjust to change the sound from each speaker apparatus 20 from stereophonic to monophonic.

The speaker apparatus 20 can be configured to receive any of a wide ranging variety of audio drivers of any size, shape, or configuration. In some embodiments, the speaker apparatus 20 can be configured to receive and support separate tweeter, mid range, and/or bass range audio drivers. In some embodiments, the speaker apparatus 20 can be configured to receive and support other adjustable and non-adjustable audio signal controls, such as active or passive audio signal crossovers, equalizers, audio or electronic filters, capacitors, or any other desired control units to control or enhance the listening experience.

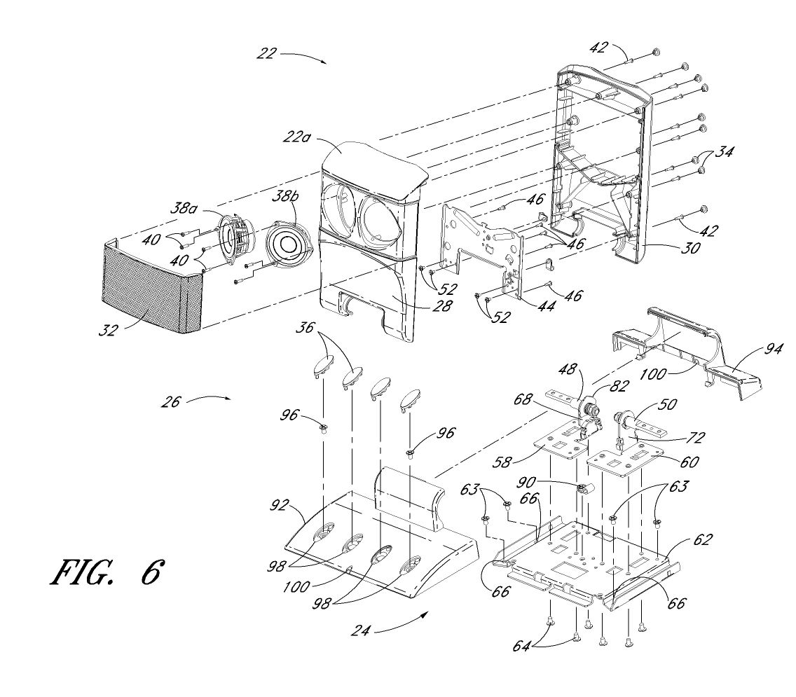

FIG. 7 is an enlarged view of a portion of the exploded assembly illustration of the speaker apparatus shown in FIG. 6. As illustrated in FIG. 7, the first enclosure member 28 can be attached to the second enclosure member 30 by screws or bolts 42. However, any other suitable fasteners or fastening method can be used to attach the first enclosure member 28 to the second enclosure member 30 including, without limitation, bolts, pins, rivets, straps, snaps, welds, adhesive, or any combination of the foregoing. Additionally, plugs 34 can be used to seal the fastener holes after the screws 42 have been installed. Additionally, a speaker housing bracket 44 can be attached to the inside of the first enclosure member 28 using screws 46 that are threadably received by threaded bosses formed on the first enclosure member 28. In some embodiments, the speaker housing bracket 44 can be attached to the inside of the second enclosure member 30 using screws 46 that are preferably threadably received by threaded bosses formed on the second enclosure member 30. However, any other suitable fasteners or fastening method can be used to attach the speaker housing bracket 44 to the first enclosure member 28 or second enclosure member 30 including, without limitation, bolts, pins, rivets, straps, snaps, welds, adhesive, or any combination of the foregoing.

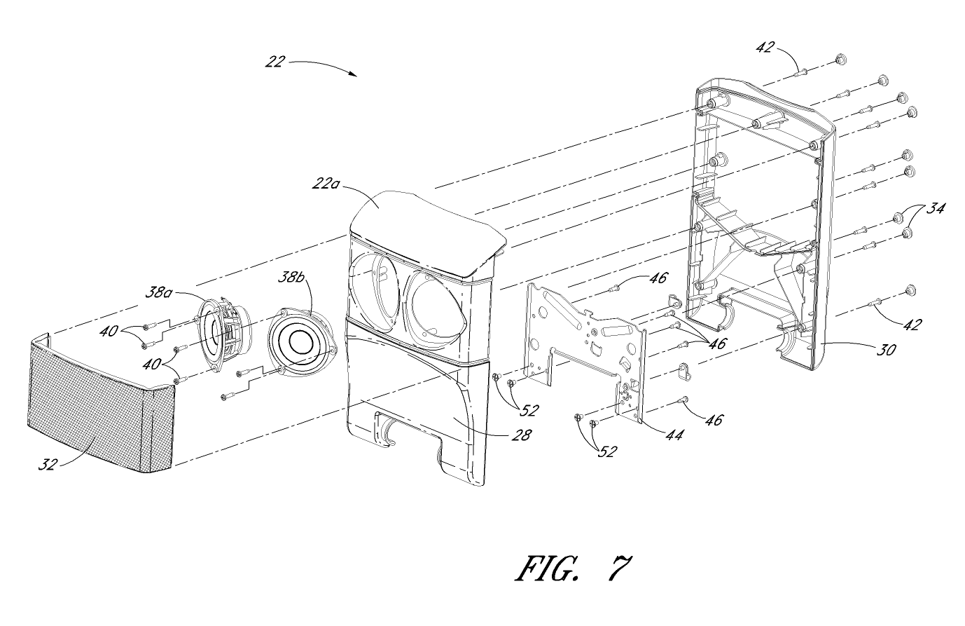

FIG. 8 is a perspective view of the back of a portion of the speaker apparatus 20 from FIG. 1, showing a portion of the speaker housing member 22 in an upward position. In FIG. 8, the second enclosure member 30 has been removed from the speaker apparatus 20 for clarity of illustration. As illustrated most clearly in FIGS. 6 and 8, the hinge assembly 26 comprises a pair of shaft members 48, 50. The shaft members 48, 50 are attached to the speaker housing bracket 44 using screws 52, although any suitable fasteners or fastening method can be used to attach the shaft members 48, 50 to the speaker housing bracket 44 including, without limitation, bolts, pins, rivets, straps, snaps, welds, adhesive, or any combination of the foregoing.

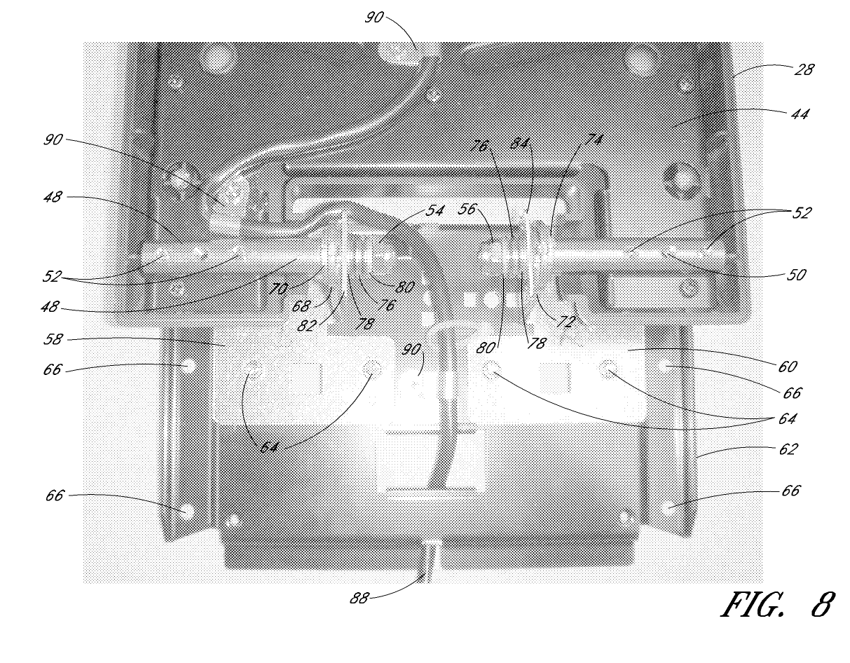

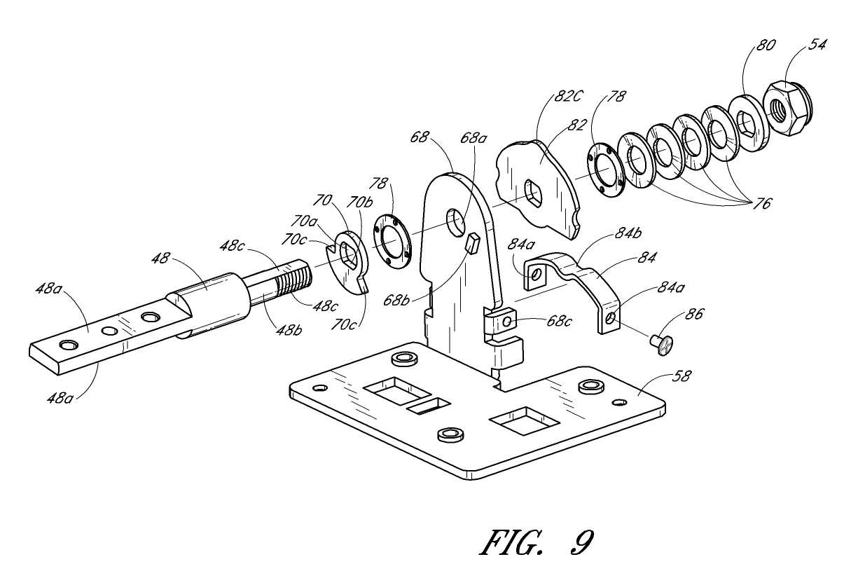

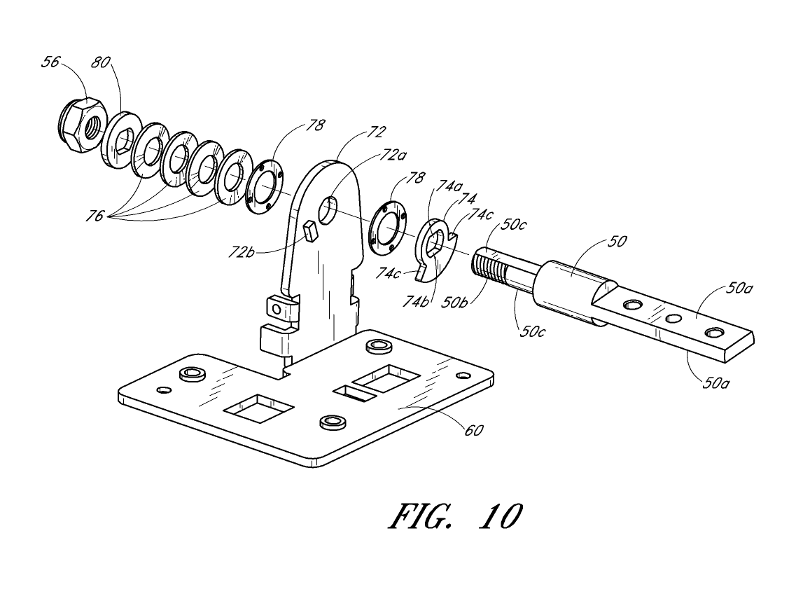

FIG. 9 is an exploded perspective view of a first portion of the hinge assembly 26 illustrated in FIG. 6. In particular, FIG. 9 illustrates some of the components that can be supported by a first hinge bracket 58 or shaft member 48. FIG. 10 is an exploded perspective view of a second portion of the hinge assembly 26 illustrated in FIG. 6. In particular, FIG. 10 illustrates some of the components that can be supported by a second hinge bracket 60 or shaft member 50.

FIG. 11 is a perspective view of the shaft members 48, 50 from FIGS. 9 and 10. With reference to FIGS. 6, 8, and 9, the shaft members 48, 50 are preferably configured to be fixed to the speaker housing bracket 44 so as not to rotate relative to the speaker housing bracket 44.

In some embodiments, the shaft members 48, 50 can be configured to have axially oriented flat surfaces 48a, 50a that abut against the speaker housing bracket 44 to prevent the shaft members 48, 50 from rotating relative to the speaker housing bracket 44. In some embodiments, as illustrated most clearly in FIGS. 9, 10, and 11, the shaft members 48, 50 can each have a threaded end portion 48b, 50b, respectively, to threadably receive nuts 54, 56, respectively. Additionally, in some embodiments, the shaft members 48, 50 can each have opposing, planar surfaces 48c, 50c formed on the threaded end portion 48b, 50b, respectively. In some embodiments, the shaft members 48, 50 are identically configured.

As illustrated in FIG. 6, the hinge assembly 26 can also comprise a first hinge bracket 58, a second hinge bracket 60, and a mounting bracket 62. The first hinge bracket 58 and second hinge bracket 60 can each be configured to provide a planar surface that can be positioned adjacent to the mounting bracket 62 and supported by the mounting bracket 62 and by a plurality of screws 64 or any other fasteners or fastening methods including, without limitation, bolts, pins, rivets, straps, snaps, welds, adhesive, or any combination of the foregoing. The mounting bracket 62 can be configured to be mounted to the desired support surface on the spa or other object to which the user desires to mount the speaker apparatus 20. In particular, the mounting bracket 62 can comprise one or more through holes 66 through which screws, bolts, or other suitable fasteners 63 can pass to attach the mounting bracket 62 to the desired support surface.

In some embodiments, as illustrated in FIGS. 8 and 9, the first hinge bracket 58 can comprise a support tab 68 that is preferably configured to receive and provide support to at least the threaded end portion of the shaft member 48. In particular, in some embodiments, the support tab 68 can comprise an opening 68a sized and shaped to receive and support a portion of the outside surface of at least the threaded portion 48b of the shaft member 48. In the illustrated embodiment, the shaft member 48 and support tab 68 are preferably configured so that the shaft member 48 is free to rotate within the opening 68a in the support tab 68.

FIG. 12 is a perspective view of a limit member 70 from FIGS. 9 and 10. The limit member 70 can be supported by the shaft member 48 as illustrated in FIGS. 8 and 9. The limit member 70 preferably has an axial opening 70a that is sized and configured to be similar to, but slightly larger than, the size and configuration of the outside surface of the threaded end portion 48b of the shaft member 48. Accordingly, as illustrated in FIG. 12, the opening 70a is configured to define two opposing, generally planar surfaces 70b that correspond with the planar surfaces 48c of the shaft member 48. In this configuration, the threaded end portion 48b of the shaft member 48 can be inserted through the opening 70a of the limit member 70 such that the limit member 70 rotates in unison with the shaft member 48. The limit member 70 preferably has two abutment surfaces 70c and the support tab 68 preferably has an abutment protrusion 68b that can limit the range of rotation of the limit member 70 and, hence, the shaft member 48 and speaker housing member 22, relative to the support tab 68. Thus, the range of angular rotation of the speaker housing member 22 can be limited by the limit member 70 as described above, in addition to being limited by contact with the spa surface or bracket member 24 as described below.

Similarly, in some embodiments, as illustrated in FIGS. 8 and 10, the second hinge bracket 60 can comprise a support tab 72 that is preferably configured to receive and provide support to at least the threaded end portion of the shaft member 50. In particular, in some embodiments, the support tab 72 can comprise an opening 72a sized and shaped to receive and support a portion of the outside surface of at least the threaded portion 50b of the shaft member 50. In the illustrated embodiment, the shaft member 50 and support tab 68 are configured so that the shaft member 50 is free to rotate within the opening 72a in the support tab 72.

A limit member 74 is supported by the shaft member 50 as illustrated in FIGS. 8 and 10. The limit member 74 preferably has an axial opening 74a that is preferably sized and configured to be similar to, but slightly larger than, the size and configuration of the outside surface of the threaded end portion 50b of the shaft member 50. Accordingly, as illustrated in FIG. 12, the opening 74a is preferably configured to define two opposing, generally planar surfaces 74b that correspond with the planar surfaces 50c of the shaft member 50. In this configuration, the threaded end portion 50b of the shaft member 50 can be inserted through the opening 74a of the limit member 74 such that the limit member 74 rotates in unison with the shaft member 50. Additionally, the limit member 74 preferably has two abutment surfaces 74c and the support tab 72 preferably has an abutment protrusion 72b that can limit the range of rotation of the limit member 74 and, hence, the shaft member 50 and speaker housing member 22, relative to the support tab 68. Thus, in some embodiments, the range of angular rotation of the speaker housing member 22 can be limited by the limit member 74 as described above, in addition to being limited by contact with the spa surface or bracket member 24 as described below. In some embodiments, the hinge assembly 26 is preferably configured so as to not impose limits in the range of angular rotation of the speaker housing member 22 relative to the bracket member 24.

Thus, in some embodiments, with the mounting bracket 62 preferably attached to and supported by a desired support surface, the speaker housing member 22 is preferably supported by the mounting bracket 62 as described above. Because the shaft members 48, 50 can be free to rotate relative to the support tabs 68, 72 as described above, the speaker housing member 22 can rotate relative to the mounting bracket 62, or to the bracket member 24, about the axial centerlines of the shaft members 48, 50.

The range of rotation of the speaker housing member 22 relative to the mounting bracket 62 can be bounded by the physical contact of the speaker housing member 22 with other objects, such as the spa or the support surface to which the mounting bracket 62 is attached, the mounting bracket 62, or any other components comprising the bracket member 24, such as the plastic covers supported by the mounting bracket 62, as described more fully below.

As described above, the speaker housing member 22 can rotate between at least a substantially upward position and a substantially downward position. Again, in some embodiments, the range of rotation may be limited only by the contact of the speaker housing member 22 with the spa supporting surface or by the contact of the speaker housing member 22 with the bracket member 24. Therefore, in some embodiments, the speaker housing member 22 of an unmounted speaker apparatus 20 (i.e., the speaker apparatus 20 before it has been attached to a spa or other support surface) can rotate about a range that is approximately 160 degrees or less, approximately 180 degrees or less, approximately 200 degrees or less, approximately 220 degrees or less, approximately 240 degrees or less, approximately 300 degrees or less, or approximately 350 degrees or less.

In some embodiments, the hinge assembly 26 is configured to support the speaker housing member 22 at any angular orientation of the speaker housing member 22 that a user desires within the unobstructed range of the speaker housing member 22. For example, if a user desires to position the speaker housing member 22 so that the speaker housing member 22 protrudes normal to the spa mounting surface (i.e., such that the front face of the speaker housing member 22 faces generally in an upward direction), in some embodiments, the hinge assembly 26 is preferably configured such that the speaker housing member 22 will remain in this position without further support from the user.

In some embodiments, the hinge assembly 26 can be configured to provide a preferably adjustable amount of resistance to the rotation of the speaker housing member 22 relative to the mounting bracket 62 or to the bracket member 24. Accordingly, the amount of resistance that can be provided by the hinge assembly 26 is preferably large enough to hold the speaker housing member 22 at any desired angular orientation, while not exceeding an amount that would make it difficult for the user to rotate the speaker housing member 22.

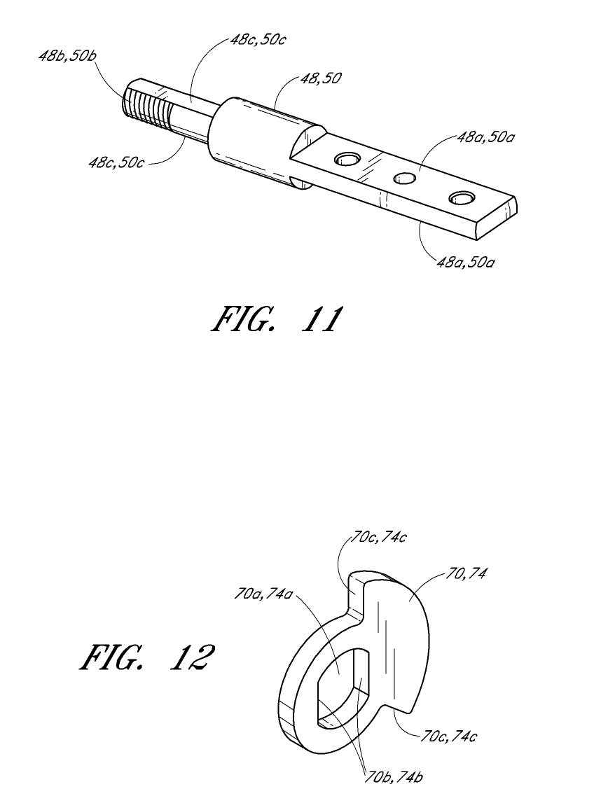

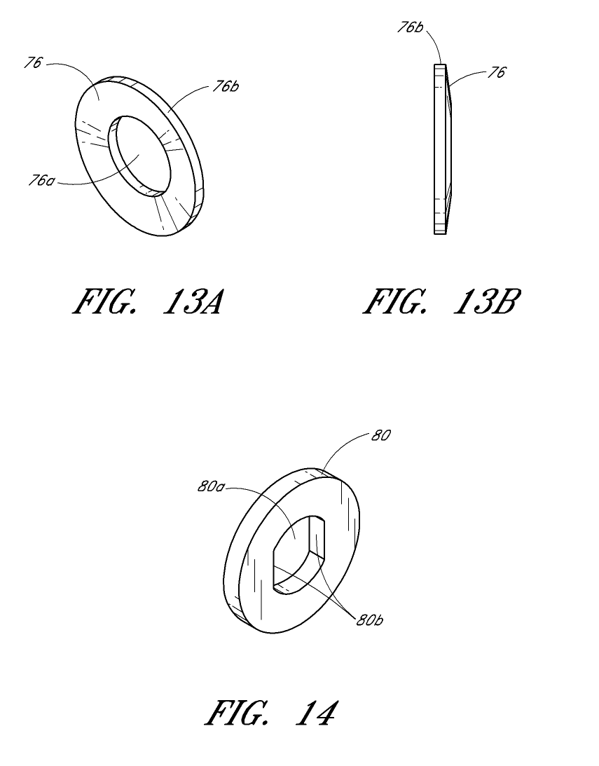

Means for providing an adjustable level of resistance to the hinge assembly 26 is illustrated in FIGS. 8, 9, and 10, and will now be described. As illustrated therein, one or more beveled or wave washers 76 are preferably supported by each of the shaft members 48, 50, and are positioned between one or more preferably generally flat annular washers 78, 80. However, the annular washers 78, 80 are not required. In some embodiments, as illustrated most clearly in FIGS. 13A and 13B, the wave washers 76 are preferably non-planar. In some embodiments, the wave washers 76 are preferably generally conical in shape, defining a narrow conical portion (i.e., the portion of the wave washer 76 near the through hole 76a penetrating through the wave washers 76) and a wide conical portion (i.e., the portion of the wave washer 76 near the outer circumference 76b of the wave washer 76). However, the wave washers 76 can define any shape, such as a helical spring, or be configured in any manner that will allow the wave washers 76 to produce a range of reactive forces. The magnitude of the reactive force in the aforementioned range can be approximately equivalent to a compressive force that is exerted on the wave washer 76. In the illustrated embodiment, the compressive force exerted on each wave washer 76 is provided by tightening the nuts 54, 56 on each of the shaft members 48, 50, respectively, to compress and, hence, elastically deform each of the wave washers 76.

In the embodiments where the wave washers 76 are generally conical in shape, the wave washers 76 are preferably arranged such that the narrow portion of each wave washer 76 abuts the narrow portion of the adjacent wave washer 76 and, accordingly, the wide portion of each wave washer 76 either abuts the wide portion of the adjacent wave washer 76, abuts a generally flat annular washer 78 or 80, or abuts the nut 54, 56, or the support tab 68, 72. In some embodiments, only one wave washer 76 is preferably supported on each of the shaft members 48, 50. In some embodiments, two, four, six or more wave washers 76 can be supported by each of the shaft members 48, 50.

Further, in some embodiments, as illustrated most clearly in FIG. 14, the washer 80 preferably has an axial opening 80a that is preferably sized and configured to be similar to, but slightly larger than, the size and configuration of the outside surface of the threaded end portion 48b, 50b of each shaft member 48, 50. Accordingly, as illustrated in FIG. 14, the opening 80a is preferably configured to define two opposing, generally planar surfaces 80b that correspond with the planar surfaces 48c of the shaft member 48 and planar surfaces 50c of the shaft member 50. In this configuration, the threaded end portion 48b, 50b of each shaft member 48, 50 can be inserted through the opening 80a of each washer 80 such that each washer 80 rotates in unison with each shaft member 48, 50. In some embodiments, each washer 80 preferably rotates in unison with each shaft member 48, 50 so as to not rotate in unison with the wave washers 76 and, hence, so as to avoid exerting rotational forces on each nut 54, 56 that can cause such nuts 54, 56 to loosen as the hinge assembly 26 rotates.

In some embodiments, the means for providing an adjustable level of resistance to the hinge assembly 26 can be provided by positioning a spring (other than a wave washer, such as a helical spring) between a pair of flat, annular washers (i.e., in place of the wave washers 76 described above). In some embodiments, the means for providing an adjustable level of resistance to the hinge assembly 26 can be provided by positioning a compressible, elastomeric spring (not illustrated) between a pair of flat, annular washers (i.e., in place of the wave washers 76 described above). In these embodiments, the level of resistance can be adjusted by tightening the nuts 54, 56 on each of the shaft members 48, 50, respectively, to compress and, hence, elastically deform each of the springs, similar to the aforementioned embodiments.

In some embodiments, the hinge assembly 26 can further comprise a wound spring or other spring mechanism that biases the speaker housing member 22 to the upward position. In such embodiments, the speaker housing member 22 would preferably be held in the downward position by a latch member of the type typically used in the art, including the push-push latch mechanism and other latch mechanism embodiments described in U.S. patent application Ser. No. 11/846,970 filed on Aug. 29, 2007 titled “Speaker,” which is hereby incorporated by reference in its entirety as if fully set forth herein.

In some embodiments, the latch member can comprise components that are positioned on the speaker housing member 22 and/or the bracket member 24. A fastener such as, but not limited to, a hook and loop fastener could be used to retain the speaker housing member 22 in the downward position. A damper can be incorporated into the hinge assembly 26 to control the rate of rotation of the speaker housing member 22 relative to the bracket member 24.

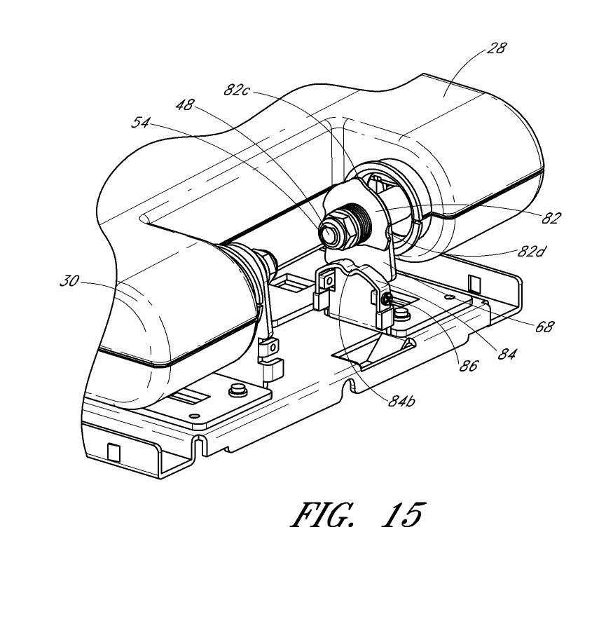

FIG. 15 is a perspective view of a portion of the speaker apparatus from FIG. 1 with a first bracket cover 92 and a second bracket cover 94 removed to show the hinge assembly 26. The shaft member 48 is supported by the support tab 68 of the first hinge bracket 58, as well as other nearby components. For reference, the portion of the speaker housing member 22 that is illustrated in FIG. 15 is positioned in the downward or stowed position.

As is illustrated in FIGS. 9 and 15, a first index member 82 is positioned on the shaft member 48, and a second index member 84 can be supported by the support tab 68. The first index member 82 and second index member 84 are preferably configured to alert the user when the speaker housing member 22 has been rotated to the generally upward position relative to the bracket member 24. In some embodiments, this occurs when a portion of the first index member 82 is aligned with a portion of the second index member 84, as discussed below.

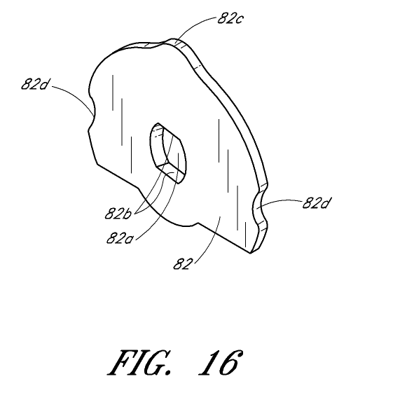

FIG. 16 is a perspective view of a first index member 82 from FIG. 15. The first index member 82 can be supported by the shaft member 48 as illustrated in FIG. 8. The first index member 82 preferably has an axial opening 82a that is sized and configured to be similar to, but slightly larger than, the size and configuration of the outside surface of the threaded end portion 48b of the shaft member 48. Accordingly, as illustrated in FIG. 16, the opening 82a is preferably configured to define two opposing, generally planar surfaces 82b that correspond with the planar surfaces 48c of the shaft member 48. In this configuration, the threaded end portion 48b of the shaft member 48 can be inserted through the opening 82a of the first index member 82 such that the first index member 82 rotates in unison with the shaft member 48. Additionally, the first index member 82 defines a protruding portion 82c and one or more indention portions 82d.

As illustrated in FIGS. 9 and 15, the second index member 84 can be attached to the support tab 68 by screws 86 passing through opposing holes 84a and threading into the threaded holes 68c in the support tab 68. The second index member 84 preferably also comprises an indented portion 84b. The first index member 82 and second index member 84 are preferably sized and configured such that, when the first index member 82 is rotated to a predetermined angle (i.e., as the speaker housing member 22 is rotated by a user relative to the bracket member 24), based on the configuration and position of at least the first index member 82 and the second index member 84, the protruding portion 82c will come into contact with the second index member 84. When this occurs, the user may be required to increase the amount of force applied to the speaker housing member 22 to further rotate the speaker housing member 22 relative to the bracket member 24. As the protruding portion 82c continues to be rotated relative to the second index member 84, the second index member 84 will elastically deflect away from the protruding portion 82c to allow the protruding portion 82c to continue to translate relative to the second index member 84. Thus, as the protruding portion 82c continues to rotate relative to the second index member 84, the user will preferably feel a slight increase in the rotational resistance of the speaker housing member 22 relative to the bracket member 24. As the speaker housing member 22 is rotated such that the protruding portion 82c becomes aligned with the indented portion 84b, the user will preferably feel the rotational resistance noticeably decrease, and the speaker housing member 22 will be biased in that position. This position is preferably the upward position of the speaker housing member 22.

The speaker housing member 22 can be further rotated beyond the upward position by exerting a force on the speaker housing member 22 sufficient to cause the protruding portion 82c to deflect the second index member 84 and rotate past the indention portion 84b of the second index member 84. Additionally, to return the speaker housing member 22 to the downward position, the user can exert a force on the speaker housing member 22 in the opposite direction sufficient to cause the protruding portion 82c to deflect the second index member 84 and rotate out of contact with the indention portion 84b of the second index member 84. In some embodiments, the first index member 82 and/or the second index member 84 can be also or alternatively mounted on the shaft member 50 and support tab 72.

As illustrated in FIG. 8, electrically conductive wires 88 are supported by wire clamps 90. The wire clamps 90 are attached to various components of the speaker apparatus 20. The wires 88 can be supported by the indention portions 82d of the first index member 82. As illustrated in FIG. 2, the wires 88 can be routed along the supporting surface of the spa 21 or other object that supports the speaker apparatus 20. Alternatively, the user may wish to channel the wires 88 through an opening formed by the user in the supporting surface such that the wires 88 are not visible below the bracket member 24.

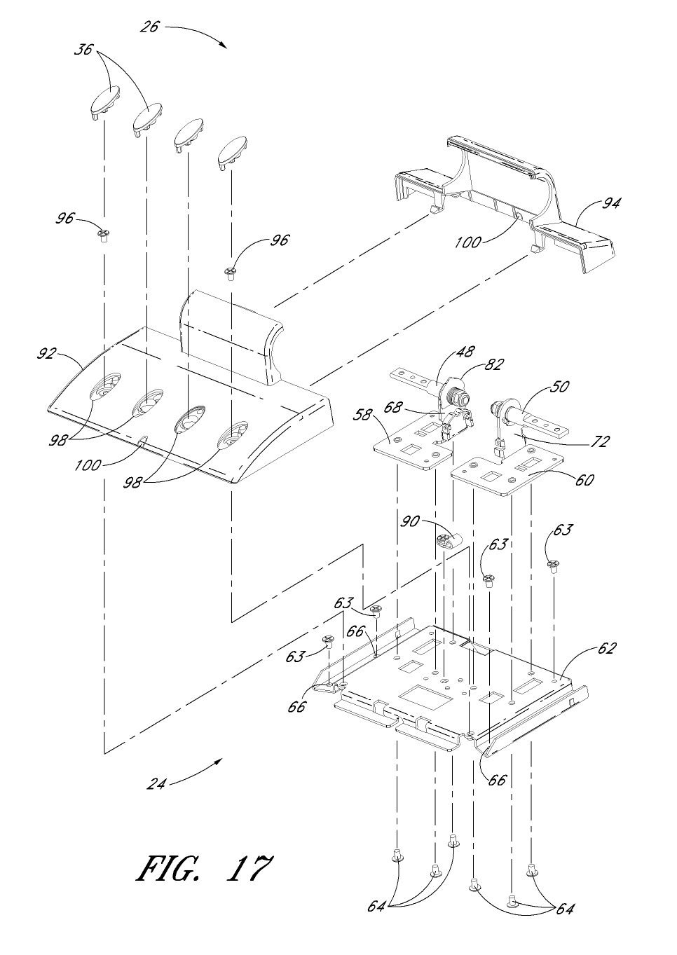

FIG. 17 is an enlarged view of a lower portion of the exploded assembly illustrated in FIG. 6. The bracket member 24 and hinge assembly 26 can be covered and protected by a first bracket cover 92 and a second bracket cover 94. The first bracket cover 92 and second bracket cover 94 are preferably configured to cover the mounting bracket 62, first hinge bracket 58, second hinge bracket 60, shaft members 48, 50, and other adjacent or related components. As will be discussed below, the first bracket cover 92 and second bracket cover 94 are attached to the mounting bracket 62 by screws 96 after the mounting bracket 62 has been attached to the desired mounting surface. However, any other suitable fasteners or fastening method can be used to attach the first bracket cover 92 and second bracket cover 94 to the mounting bracket 62 including, without limitation, bolts, pins, rivets, straps, snaps, welds, adhesive, or any combination of the foregoing.

The screws 96 are inserted through the openings 98 in the first bracket cover 92. Plugs 36 can be inserted in the openings 98 to seal the openings 98. Also, break outs 100 can be formed in either or both of the first bracket cover 92 and the second bracket cover 94 to allow the audio or other wires to be routed to and from the speaker apparatus 20.

In some embodiments, the speaker apparatus 20 can further comprise a signal receiver or signal detector of the type known in the art or later developed, or as described in U.S. patent application Ser. No. 11/846,970 filed on Aug. 29, 2007 titled “Speaker,” which is hereby incorporated by reference in its entirety as if fully set forth herein. The signal detector can be positioned in an opening in an upper portion of the first enclosure member 28, and can be configured to receive wireless control signals. The control signals can be infrared signals or other wireless communications signals. The control signals preferably allow a user to remotely control the audio functions of the speaker apparatus 20 and/or other audio components connected to the speaker apparatus 20, such as an audio or video signal source, an amplifier, a subwoofer, another speaker apparatus 20, or any combination or plurality of the foregoing or any other suitable controls or the controls described below. Further, the signal detector can be configured to allow the user to remotely control certain functions related to the operation of the spa, lighting, or other related components. The speaker apparatus 20 can include a printed circuit board or other circuitry mounted to the speaker housing member 22 and operatively connected to the signal detector to receive control signals so that the user can control the speaker apparatus 20 and/or other components such as, but not limited, those described above.

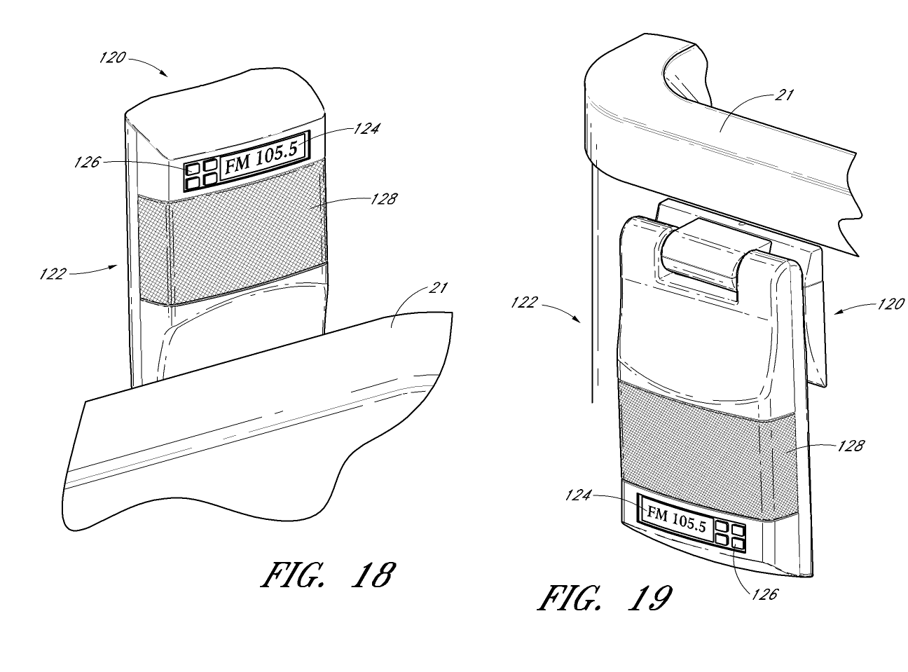

FIG. 18 is a perspective view of a front portion of a speaker apparatus 120 according to another embodiment of the present invention, showing a speaker housing member 122 in an upward or extended position. The components and features of the speaker apparatus 120 are the same as described above with respect to the speaker apparatus illustrated in FIG. 1 except that the speaker apparatus 120 further includes a visual display 124.

The visual display 124 provides information to a user of the speaker apparatus 120 such as, but not limited to, the current time of day, the volume level of the speaker apparatus 120, the audio signal source (e.g., CD player, stereo receiver, DVD player, MP3 player, auxiliary source, etc.), the FM or AM station frequency, the sound mode of the speaker apparatus 120 (e.g., stereophonic versus monophonic mode), the audio tone of the speaker apparatus 120 (e.g., base, treble, balance, or fader), and/or suitable information regarding the audio or spa settings or controls, or the settings or controls of other components that can be adjusted with the speaker apparatus 120. In some embodiments, the visual display 124 can be a light-emitting diode (LED) display, or other suitable display.

The speaker apparatus 120 can further include a control panel 126. The control panel 126 allows a user to control certain aspects of the speaker apparatus 120, audio signal source (e.g., CD player, stereo receiver, DVD player, MP3 player, auxiliary source, etc.), the spa controls such as lighting and jet configuration, patio, ceiling, or other surrounding lighting, or other suitable components. For example, in some embodiments, the control panel 126 can be configured to control the volume level of the speaker apparatus 120, the audio signal source (e.g., CD player, stereo receiver, DVD player, MP3 player, auxiliary source, etc.), the FM or AM station frequency, the sound mode of the speaker apparatus 120 (e.g., stereophonic versus monophonic mode), the audio tone of the speaker apparatus 120 (e.g., base, treble, balance, or fader), subwoofer control, and/or suitable information regarding the spa controls or other controls that can be adjusted with the speaker apparatus 120.

In some embodiments, the visual display 124 and control panel 126 can be supported by a first enclosure member 128. The speaker apparatus 120 can include a printed circuit board or other circuitry mounted to the speaker housing member 122 and operatively connected to the visual display 124 to control the visual display 124. In some embodiments, the printed circuit board or other circuitry described above can be operatively connected to the control panel 126 to receive control signals from the control panel 126 so that the user can control the speaker apparatus 20 and/or other components such as, but not limited, those described above.

FIG. 19 is a perspective view of a front portion of the speaker apparatus 120, showing the speaker housing member in a stowed or downward position. As illustrated therein, the speaker apparatus 120 described above can be further configured such that the orientation of the visual display 124 is position sensitive. For example, when the speaker housing member 122 is in an upward position, the visual display 124 will adjust so that the information presented by the visual display 124 is properly oriented for a user to read. Similarly, when the speaker housing member 122 is in a downward position, i.e., where the speaker housing member 122 projects sound away from the spa, the visual display 124 can be configured to adjust the orientation of the information presented by the visual display 124 so that the information presented by the visual display 124 flips and, hence, is properly oriented for a user to read. The speaker apparatus 120 can be configured to comprise a switch, bubble sensor, or other suitable sensor to determine the orientation of the speaker housing member 122, and the control panel or circuitry above can be used to make the necessary orientation adjustments to the visual display 124. For example, in some embodiments, a switch could be mounted to the back side of the speaker housing member 122 to alert the control board of the orientation of the speaker housing member 122 and configured such that the switch would be depressed when the speaker housing member 122 is in the downward position, but not depressed when the speaker housing member 122 is in the upward position.

Additionally, in some embodiments, the speaker apparatus 20 can be configured to have an AM/FM signal receiver and/or antennae so that the user can use the speaker apparatus 20 to receive and play sound transmitted over AM/FM stations. In some embodiments, the speaker apparatus 20 can include a visual display, control panel, and printed circuit board or other circuitry mounted to the speaker housing member 22 as described above to control the AM/FM signal receiver.

Any of the components described herein can be made from any of the following materials: plastic, rubber, steel, aluminum, copper, or any other suitable material or combination of materials. In particular, the brackets, screws, hinge components, shaft members, and other related components are preferably made from steel, aluminum, fiber reinforced plastics or composites, or any other suitable material to provide long-lasting durability. The enclosures and covers are preferably made from plastic in an injection molding process or other suitable manufacturing process. In some embodiments, a corrosion inhibiting coating or coatings can be applied to the components of the speaker apparatus that can be susceptible to corrosion or rust from moisture, chemicals, salt, or other contaminants.

In particular, one or more of the speaker apparatus 20 components such as, without limitation, the grill or the components comprising the housing member 22, bracket member 24, or hinge assembly 26 can be formed from materials selected for their properties of resistance to chemicals, moisture, sunlight, radiation, and/or corrosion sometimes associated with spas. For example, the grill 32 or some or all of the components comprising the housing member 22, bracket member 24, or hinge assembly 26 can be formed from a water impervious plastic through an injection molding process, or any of such components can be formed of a metal such as aluminum, steel, or other alloy. Thus, the speaker apparatus 20 can be formed of any suitable material, composite or otherwise, by any suitable manufacturing process.

As mentioned, the speaker apparatuses described herein are preferably configured to be mounted to any surface of a bathtub, pool, spa, or other water-containing object or water vehicle in any desired position. Additionally, a plurality of speaker apparatuses can be used simultaneously, as well as other audio speaker components such as a receiver, music compact disc player, DVD player, or subwoofer speaker system. Further, in some embodiments, as mentioned above, the speaker apparatuses described herein can be configured to comprise two or more preferably independently deployable and rotatable speaker apparatuses located side by side or on any desired surface.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments can be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. A speaker comprising:
a bracket member configured to attach to a generally vertical support surface,
a speaker housing having at least one audio driver; and
a structure coupling the speaker housing to the bracket member so as to allow the speaker housing to move between at least a first position and a second position relative to the bracket member, at least a portion of the speaker housing being higher than the bracket member when in the first position than when in the second position.

2. The speaker of claim 1, wherein the at least one audio driver projects sound in a first direction when the speaker housing is in the first position and projects sound in a second direction when the speaker housing is in the second position, the second direction being substantially opposite to the first direction.

3. The speaker of claim 1, wherein the structure comprises at least one coupling structure selected from the group consisting of: rotatable hinge, tongue and groove, ball-and-socket, hook and loop fastener, and screw and wingnut.

4. The speaker of claim 1, wherein the structure provides a predetermined amount of resistance to inhibit movement of the speaker housing relative to the bracket member.

5. The speaker of claim 1, wherein the speaker housing is rotatable relative to the bracket member so as to change the orientation of the audio driver relative to the bracket member.

6. The speaker of claim 5, wherein the structure comprises at least one spring configured to provide a predetermined amount of resistance to inhibit the rotation of the speaker housing relative to the bracket member.

7. The speaker of claim 1, wherein the speaker is configured to be attachable to a spa.

8. The speaker of claim 7, wherein the support surface is a side surface of the spa.

9. The speaker of claim 8, wherein at least a portion of the speaker housing is positioned above a top surface of the spa when the speaker housing is in the first position, and the speaker housing is positioned below the top surface of the spa when the speaker housing is in the second position.

10. The speaker of claim 1, further comprising a slanted upper surface, the upper surface being disposed so that when a downward force is applied to the upper surface the speaker housing will move from the first position toward the second position.

11. The speaker of claim 1, wherein the speaker housing supports at least two audio drivers configured to provide stereophonic sound.

12. The speaker of claim 1, further comprising a detector for receiving wireless communication signals.

13. The speaker apparatus of claim 1, further comprising a receiver for receiving at least an FM signal.

14. The speaker of claim 1, further comprising a control panel for receiving a user selected volume level for sound produced by the speaker.

15. The speaker of claim 1, further comprising a control panel for receiving a user selected spa jet configuration.

16. A spa speaker comprising:
a bracket member configured to be fixed to a side of a spa;
a speaker housing supporting at least one audio driver; and
a structure movably coupling the bracket member to the speaker housing so as to allow the speaker housing to rotate relative to the bracket member and between at least an extended position and a stowed position, the speaker housing being disposed above a top surface of the spa when in the extended position so as to direct sound in a general direction toward the spa, and the speaker housing being disposed below the top surface of the spa when in the stowed position so as to direct sound in a general direction away from the spa.

17. The spa speaker of claim 16, wherein the structure is a hinge, the hinge being configured to allow the speaker housing to rotate approximately 180 degrees between the extended and stowed positions.

18. The spa speaker of claim 16, further comprising a display configured to display at least one setting selected from the group consisting of: audio volume level, audio signal source, AM frequency, FM frequency, and audio tone.

19. The spa speaker of claim 16, further comprising a visual display for displaying data, the visual display being configured so that the data is displayed in an upright orientation when the speaker housing is in the extend and stowed positions.

20. A method of attaching a low-profile, flip-up speaker to a spa, the method comprising:
providing a speaker having a bracket member, a speaker housing, a coupling structure between the bracket member and the speaker housing, and at least one audio driver disposed within the speaker housing; and
fixing the bracket member to a supporting surface of the spa such that the bracket member is located below a top surface of the spa, wherein the speaker housing is rotatable relative to the fixed bracket member and between at least an extended position and a stowed position, the speaker housing being disposed above the top surface of the spa when in the extended position so as to direct sound in a general direction toward the spa, and the speaker housing being disposed below the top surface of the spa when in the stowed position.
